(19) United States
(12) Patent Application Publication
(10) Pub. No.: US 2024/0339632 A1
(43) Pub. Date: Oct. 10, 2024

(54) METHOD FOR PRODUCING A BIPOLAR PLATE LAYER FOR A BIPOLAR PLATE OF AN ELECTROCHEMICAL UNIT, BIPOLAR PLATE LAYER FOR A BIPOLAR PLATE OF AN ELECTROCHEMICAL UNIT AND ELECTROCHEMICAL UNIT FOR AN ELECTROCHEMICAL DEVICE

(71) Applicant: EKPO FUEL CELL TECHNOLOGIES GMBH, Dettingen (DE)

(72) Inventor: Andreas Schmid, Mössingen (DE)

(21) Appl. No.: 18/747,955

(22) Filed: Jun. 19, 2024

Related U.S. Application Data
(63) Continuation of application No. PCT/EP2022/086967, filed on Dec. 20, 2022.

(30) Foreign Application Priority Data
Dec. 21, 2021 (DE) 10 2021 134 038.1

(51) Int. Cl. H01M 8/0206; C25B 11/032; C25B 13/02; C25B 13/05; H01M 8/0228; H01M 8/0254; H01M 8/026; H01M 8/1004

(52) U.S. Cl. CPC H01M 8/0206; C25B 11/032; C25B 13/02; C25B 13/05; H01M 8/0228; H01M 8/0254; H01M 8/026; H01M 8/1004

(57) ABSTRACT

In order to provide a method for manufacturing a bipolar plate layer for a bipolar plate of an electrochemical unit of an electrochemical device having the method steps of:
providing a starting material for the bipolar plate layer; and
shaping the starting material such that an edge web which borders a flow field of the bipolar plate layer is formed,
which is configured to be carried out simply and reliably even when large numbers of bipolar plate layers are to be manufactured,
it is proposed that the method comprises the following:
separating out gas passage openings from an edge web portion of the starting material, wherein after the gas passage openings have been separated out the edge web portion is shaped such that the edge web is formed from the edge web portion.

### RELATED APPLICATION

This application is a continuation of international application number PCT/EP2022/086967 filed on Dec. 20, 2022, and claims the benefit of German patent application number 10 2021 134 038.1 filed on Dec. 21, 2021.

The present disclosure relates to the subject matter disclosed in international application number PCT/EP2022/086967 of Dec. 20, 2022 and German patent application number 10 2021 134 038.1 of Dec. 21, 2021, which are incorporated herein by reference in their entirety and for all purposes.

### FIELD OF THE DISCLOSURE

The present invention relates to a method for manufacturing a bipolar plate layer for a bipolar plate of an electrochemical unit of an electrochemical device, wherein the method comprises the following:
providing a starting material for the bipolar plate layer; and
shaping the starting material such that an edge web which borders a flow field of the bipolar plate layer is formed.

### BACKGROUND

The electrochemical device may be for example a fuel cell device or an electrolyser.

The electrochemical unit may be for example a fuel cell unit or an electrolysis unit.

The edge web is provided in certain regions with gas passage openings, through which a gas which flows through a gas flow field during operation of the electrochemical device is configured to flow.

If the flow field is an anode gas flow field, then an anode gas is supplied through the gas passage openings from a connection duct for anode gas, which runs through certain regions of the edge web, to the flow field, or anode gas is discharged through the gas passage openings into a connection duct which runs through certain regions of the edge web.

If the flow field is a cathode gas flow field, then a cathode gas is supplied through the gas passage openings from a connection duct for cathode gas, which runs through certain regions of the edge web, or cathode gas is discharged through the gas passage openings into a connection duct for cathode gas which runs through certain regions of the edge web.

In the case of known methods for manufacturing a bipolar plate layer for a bipolar plate of an electrochemical unit of an electrochemical device, the edge web is formed from a planar starting material by a shaping procedure, and after the shaping procedure the gas passage openings are cut out of a flank of the edge web that faces the flow field and is on the flow field side, by a laser cutting procedure. The relevant portion of the edge web then forms a flow port through which the anode gas or cathode gas can flow out of the connection duct into the flow field or out of the flow field into the connection duct.

Manufacture of the gas passage openings by a laser cutting procedure is an additional process step, which complicates the methods for manufacturing a bipolar plate layer and tends to make them unsuitable for low-cost industrial mass production.

### SUMMARY OF THE INVENTION

The object of the present invention is to provide a method for manufacturing a bipolar plate layer for a bipolar plate of an electrochemical unit of an electrochemical device of the type mentioned in the introduction that is configured to be carried out simply and reliably even when large numbers of bipolar plate layers are to be manufactured.

This object is achieved according to the invention with a method for manufacturing a bipolar plate layer for a bipolar plate of an electrochemical unit of an electrochemical device according to the precharacterising clause of Claim 1 by the following method step:
separating out gas passage openings from an edge web portion of the starting material, wherein after the gas passage openings have been separated out the edge web portion is shaped such that the edge web is formed from the edge web portion.

The underlying concept of the present invention is to separate the gas passage openings out of the starting material before the edge web portion is shaped such that the edge web is formed from the edge web portion.

Separating the gas passage openings out of the starting material may thus be performed on a planar, unshaped starting material, with the result that inaccuracies and tolerances of the shaping procedure do not have to be taken into account during the separating-out procedure, and the separating-out procedure is thus configured to be carried out particularly simply and reliably.

The additional process step of laser cutting, necessary in the case of known manufacturing methods for the bipolar plate layer, after the edge web portion has been shaped into the edge web can in this case be dispensed with.

The method according to the invention for manufacturing a bipolar plate layer for a bipolar plate of an electrochemical unit of an electrochemical device may thus be carried out in a progressive tool by a progressive process.

In a first stage of the progressive process, and in a first station of the progressive tool, the gas passage openings are separated out of the edge web portion of the starting material.

In a second stage of the progressive process, and in a second station of the progressive tool, the edge web portion is shaped into the edge web. Preferably in this second stage of the progressive process, the flow field is also formed on the bipolar plate layer by a shaping procedure.

Here, it is favourable if the edge web and the gas passage openings take a form such that the gas passage openings which are separated out of the starting material before the shaping procedure are prevented from being widened to too great an extent, as a result of the change in shape during the shaping procedure and/or as a result of the shaping work, and from possibly extending into a duct of the flow field that is adjacent to the edge web and/or a crest region of the edge web.

In a preferred embodiment of the invention, it is provided for the gas passage openings to be separated out of the edge web portion of the starting material by being punched out.

A punching out procedure is particularly easy to integrate into a progressive process or progressive tool.

Because the laser cutting procedure is dispensed with, the throughput time through a device for manufacturing the bipolar plate layer may be reduced.

In a preferred embodiment of the invention, it is provided for the edge web portion of the starting material to be given a shape, after the gas passage openings have been separated out, such that the edge regions of the edge web which border the gas passage openings are inclined in relation to a main plane of the bipolar plate layer, which in the assembled condition of the bipolar plate is oriented perpendicular to a stack direction of the electrochemical device in which the electrochemical units of the electrochemical device succeed one another, by an angle (flank angle α) of less than 70°, in particular less than 60°, particularly preferably less than 45°, for example less than 30°, by way of example less than 10°.

Further, it is preferably provided for the edge regions of the edge web which border the gas passage openings to be inclined in relation to a main plane of the bipolar plate layer, which in the assembled condition of the bipolar plate is oriented perpendicular to a stack direction of the electrochemical device in which the electrochemical units of the electrochemical device succeed one another, by an angle (flank angle α) of more than 5°, particularly preferably more than 10°.

As a result of the local reduction to the flank angle α of the flank of the edge web that faces the flow field and is on the flow field side, the degree of shaping during manufacture of the edge web by the procedure of shaping out of the edge web portion of the starting material is reduced, as a result of which the change in shape during the shaping procedure of the gas passage openings which are made before the shaping procedure is also not too great.

In a particular embodiment of the invention, it is provided for the edge web portion of the starting material to be given a shape, after the gas passage openings have been separated out, such that the edge regions of the edge web which border the gas passage openings take a substantially planar form.

In the preferred case of using a planar starting material, the edge regions of the edge web which border the gas passage openings in this embodiment thus remain substantially planar even after the shaping procedure.

In another particular embodiment of the invention, it is provided for the edge web portion of the starting material to be given a shape, after the gas passage openings have been separated out, such that the edge regions of the edge web which border the gas passage openings take—as seen from the outer side of the edge web, remote from the connection duct—a convexly curved form.

Further, in a particular embodiment of the invention, it is provided for the edge web portion of the starting material to be given a shape, after the gas passage openings have been separated out, such that the edge web has a smaller height (H₁; H₂; H₃) in opening portions that are each provided with a gas passage opening than in intermediate portions of the edge web lying between two respective opening portions, where the edge web has the height H₀.

Further, it is favourable if the edge web portion of the starting material is given a shape, after the gas passage openings have been separated out, such that the height (H₁; H₂; H₃) of the edge web in the opening portions is less than 80%, in particular less than 60%, particularly preferably less than 50%, of the height (H₀) of the edge web in the intermediate portions.

In a particular embodiment of the invention, it is provided for the edge web portion of the starting material to be given a shape, after the gas passage openings have been separated out, such that a crest region of the edge web, at which the edge web has its greatest height (H₀), takes the shape of a wave as seen in a plan view of the edge web in the stack direction of the electrochemical device.

In an alternative embodiment of the invention, it is provided for the edge web portion of the starting material to be given a shape, after the gas passage openings have been separated out, such that the height of the edge web is (at least in part) the same size in the opening portions as the height (H₀) of the edge web in the intermediate portions, without a crest region of the edge web, at which the edge web has its greatest height (H₀), taking the shape of a wave as seen in a plan view of the edge web in the stack direction of the electrochemical device.

The crest region of the edge web may take a substantially planar form.

In preferred embodiments of the invention, it is provided for the gas passage openings not to extend into the crest region of the edge web.

Further, the present invention relates to a bipolar plate layer for a bipolar plate of an electrochemical unit of an electrochemical device, wherein the bipolar plate layer comprises an edge web which borders a flow field of the bipolar plate layer, wherein a plurality of gas passage openings are arranged in the edge web.

It is a further object of the present invention to provide a bipolar plate layer for a bipolar plate of an electrochemical unit of an electrochemical device of the type mentioned in the introduction that is configured to be manufactured simply and reliably even in large numbers.

This object is achieved according to the invention with a bipolar plate layer having the features of the precharacterising clause of Claim 13 in that the gas passage openings are separated out of a starting material of the bipolar plate layer by being punched out.

Punching out of the gas passage openings may in particular be performed by a progressive process that is carried out in a progressive tool.

As an alternative to this, punching out of the gas passage openings may also be performed in a transfer tool.

In order to make it possible for the gas passage openings to be punched out of the starting material of the bipolar plate layer before an edge web portion of the starting material is shaped into the edge web, it is favourable if the edge regions of the edge web which border the gas passage openings are inclined in relation to a main plane of the bipolar plate layer, which in the assembled condition of the bipolar plate layer is oriented perpendicular to a stack direction of the electrochemical device, by an angle (flank angle α) of less than 60°, in particular less than 45°, particularly preferably less than 30°, for example less than 10°.

In this case, the degree of shaping during shaping of the edge web portion into the edge web is only small, with the result that the gas passage openings that are separated out of the starting material before the shaping procedure are not widened to too great an extent.

In particular embodiments of the invention, it is provided for the edge web to have a smaller height (H₁; H₂; H₃) in opening portions that are each provided with a gas passage opening than in intermediate portions of the edge web lying between two respective opening portions, at which the edge web has its greatest height (H₀).

Further, in a particular embodiment of the invention, it may be provided for a crest region of the edge web, at which the edge web has its greatest height (H₀), to take the shape of a wave as seen in a plan view of the edge web in the stack direction of the electrochemical device in which the electrochemical units of the electrochemical device succeed one another.

Further particular embodiments of the bipolar plate layer according to the invention have already been explained above in conjunction with particular embodiments of the method according to the invention for manufacturing a bipolar plate layer.

The bipolar plate layer according to the invention is preferably manufactured by the method according to the invention for manufacturing a bipolar plate layer for a bipolar plate of an electrochemical unit of an electrochemical device.

The method according to the invention for manufacturing a bipolar plate layer for a bipolar plate of an electrochemical unit of an electrochemical device is in particular suitable for manufacturing the bipolar plate layer according to the invention for a bipolar plate of an electrochemical unit of an electrochemical device.

The bipolar plate layer according to the invention is in particular suitable as a constituent part of an electrochemical unit for an electrochemical device that comprises a bipolar plate layer according to the invention and a membrane electrode assembly comprising a gas diffusion layer.

In this context, it may be provided for an edge web of the bipolar plate layer which borders a flow field of the bipolar plate layer to be at a spacing from the gas diffusion layer in opening portions that are each provided with a gas passage opening, and to be in contact with the gas diffusion layer in intermediate portions of the edge web lying between two respective opening portions.

As a result of the present invention, the function of the gas passage openings at the flank of the edge web of the bipolar plate layer that is on the flow field side and the manufacture thereof by a progressive process may be ensured without the edge web needing to take up additional space.

In a construction of the edge web that is still compact, the shape taken by the edge web may be changed by comparison with known edge web shapes such that a change in shape in the gas passage openings during a shaping procedure, in particular a stamping procedure, is not too great, with the result that the gas passage openings may be separated out of the starting material before the shaping procedure and may still be located on the flank of the edge web that is on the flow field side.

In particular embodiments of the invention, the height of the edge web is reduced locally, at the positions of the gas passage openings. As a result, the flank angle of the flank of the edge web that is on the flow field side can be reduced at these locations, which makes it possible to separate the gas passage openings out of the starting material before the shaping procedure that produces the edge web.

In a particular embodiment of the invention, the edge web takes a wavy form such that, as a result of this wave shape of the edge web, the flank angle of the flank on the flow field side of the edge web can be reduced at the positions of the gas passage openings. In this case, the edge web is preferably furthermore in contact with an adjacent gas diffusion layer of an adjacent membrane electrode assembly at every point in its longitudinal direction.

By changing the shape of the edge web, for example in respect of the course taken by the crest region of the edge web and/or the inclination and/or the height of the flank of the edge web that is on the flow field side, the gas passage openings of the edge web are preferably manufacturable by a progressive process.

In particular, this may produce punchable gas passage opening flanks on the edge web.

By separating the gas passage openings out of the starting material before the shaping procedure by which the edge web is formed, the hitherto conventional process step of laser cutting the gas passage openings during bipolar plate production may be dispensed with, and the throughput time of the bipolar plate layers through a device for manufacturing the bipolar plate layer is reduced.

The construction of the bipolar plate layers is still compact and can be scaled up for industrial production at low cost.

The bipolar plate layer according to the invention is preferably a bipolar plate layer for a bipolar plate of an electrochemical unit that comprises a polymer-electrolyte membrane (PEM).

Further features and advantages of the invention form the subject matter of the description below, and the illustration in the drawings of exemplary embodiments.

### BRIEF DESCRIPTION OF THE DRAWINGS

FIG. 1 shows a detail of a schematic plan view of an electrochemical unit of an electrochemical device that comprises a plurality of electrochemical units succeeding one another in a stack direction, in the region of an anode gas supply and a coolant supply;

FIG. 2 shows a schematic section through the anode gas supply of the electrochemical unit from FIG. 1, along the line 2-2 in FIG. 1;

FIG. 3 shows a perspective illustration of a bipolar plate layer for a bipolar plate of an electrochemical unit of an electrochemical device, which comprises an edge web that borders a flow field of the bipolar plate layer, wherein a plurality of gas passage openings are arranged in the edge web, wherein the gas passage openings have been separated, by being punched, out of an edge web portion of a starting material before the edge web portion has been shaped into the edge web, and wherein the edge web has a smaller height in opening portions that are each provided with a gas passage opening than in intermediate portions of the edge web lying between two respective opening portions;

FIG. 4 shows a plan view from above of the bipolar plate layer from FIG. 3;

FIG. 5 shows a cross section through the bipolar plate layer from FIGS. 3 and 4, along the line 5-5 in FIG. 4;

FIG. 6 shows a side view of the edge web of the bipolar plate layer from FIGS. 3 to 5, as seen in the direction of view of the arrow 6 in FIG. 4;

FIG. 7 shows a perspective illustration of a second embodiment of a bipolar plate layer with an edge web in which gas passage openings are arranged, wherein the edge web has a smaller height in opening portions that are each provided with a gas passage opening than in intermediate portions of the edge web lying between two respective opening portions, and wherein the height of the edge web in the opening portions is more pronouncedly lowered than in the first embodiment of a bipolar plate layer that is illustrated in FIGS. 3 to 6;

FIG. 8 shows a plan view from above of the bipolar plate layer from FIG. 7;

FIG. 9 shows a cross section through the bipolar plate layer from FIGS. 7 and 8, along the line 9-9 in FIG. 8;

FIG. 10 shows a side view of the bipolar plate layer from FIGS. 7 to 9, as seen in the direction of view of the arrow 10 in FIG. 8;

FIG. 11 shows a perspective illustration of a third embodiment of a bipolar plate layer with an edge web in which gas passage openings are arranged, wherein the edge web has a smaller height in opening portions that are each provided with a gas passage opening than in intermediate portions of the edge web lying between two respective opening portions, wherein the edge regions of the edge web which border the gas passage openings take—as seen from the outer side of the edge web—a convexly curved form;

FIG. 12 shows a plan view from above of the bipolar plate layer from FIG. 11;

FIG. 13 shows a cross section through the bipolar plate layer from FIGS. 11 and 12, along the line 13-13 in FIG. 12;

FIG. 14 shows a side view of the bipolar plate layer from FIGS. 11 to 13, as seen in the direction of view of the arrow 14 in FIG. 12;

FIG. 15 shows a perspective illustration of a fourth embodiment of a bipolar plate layer with an edge web in which gas passage openings are arranged, wherein a crest region of the edge web at which the edge web has its greatest height takes the shape of a wave as seen in a plan view of the edge web from above;

FIG. 16 shows a plan view from above of the bipolar plate layer from FIG. 15;

FIG. 17 shows a cross section through the bipolar plate layer from FIGS. 15 and 16, along the line 17-17 in FIG. 16;

FIG. 18 shows a side view of the bipolar plate layer from FIGS. 15 to 17, as seen in the direction of view of the arrow 18 in FIG. 16;

FIG. 19 shows a perspective illustration of a fifth embodiment of a bipolar plate layer with an edge web in which gas passage openings are arranged, wherein the edge web has the same height in opening portions that are each provided with a gas passage opening as in intermediate portions of the edge web lying between two respective opening portions, wherein the edge regions of the edge web which border the gas passage openings take a planar form;

FIG. 20 shows a plan view from above of the bipolar plate layer from FIG. 19;

FIG. 21 shows a cross section through the bipolar plate layer from FIGS. 19 and 20, along the line 21-21 in FIG. 20;

FIG. 22 shows a side view of the bipolar plate layer from FIGS. 19 to 21, as seen in the direction of view of the arrow 22 in FIG. 20;

FIG. 23 shows a detail of a cross section through the bipolar plate layer from FIGS. 19 to 22, the edge web of which is in contact with a porous element, for example a gas diffusion layer;

FIG. 24 shows a detail of a cross section through the bipolar plate layer from FIGS. 19 to 22, the edge web of which is in contact with a thin film such as a catalyst-coated membrane (CCM) or a bipolar plate;

FIG. 25 shows a detail of a cross section through a first variant of the bipolar plate layer from FIGS. 19 to 22, in which a crest region of the edge web is provided with a coating of an elastomer material; and

FIG. 26 shows a detail of a cross section through a second variant of the bipolar plate layer from FIGS. 19 to 22, in which a crest region of the edge web is only in part provided with a coating of an elastomer material.

Like or functionally equivalent elements are designated by the same reference numerals in all the Figures.

### DETAILED DESCRIPTION OF THE INVENTION

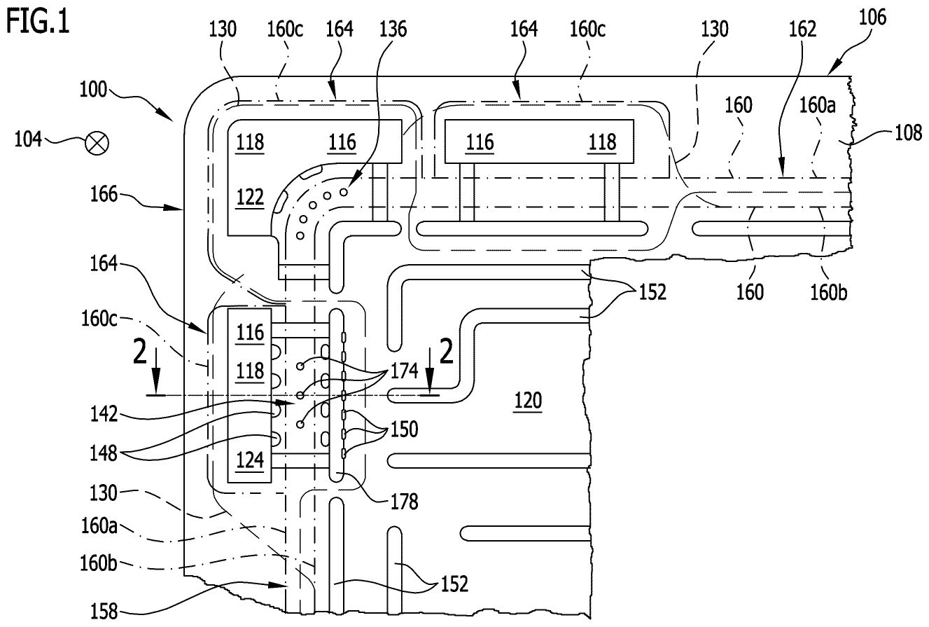

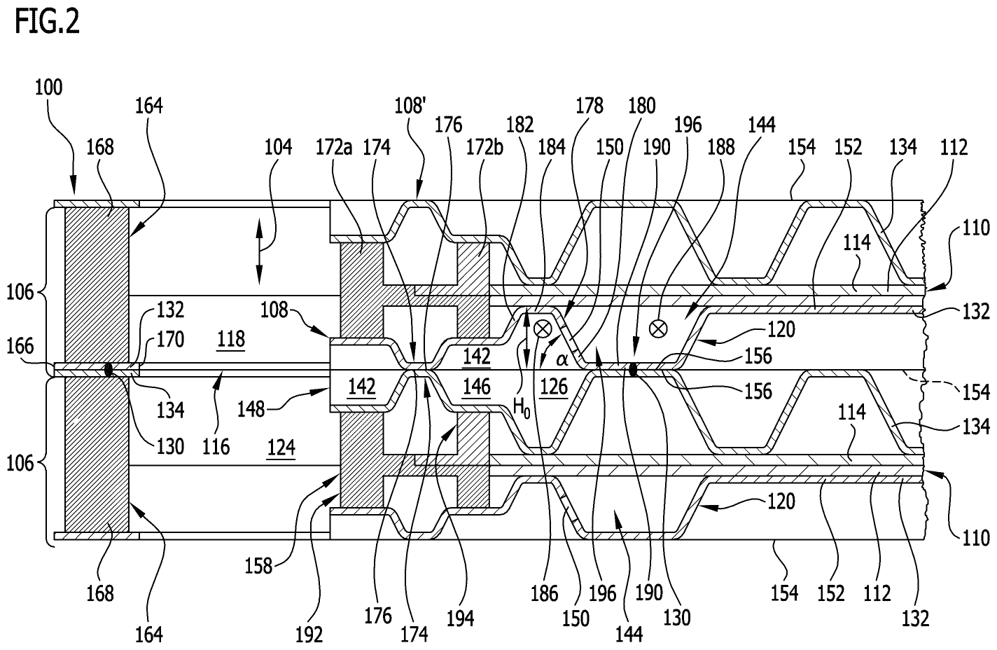

An electrochemical device that is illustrated in FIGS. 1 and 2 and is designated 100 as a whole, such as a fuel cell stack or an electrolyser, comprises a stack, which comprises a plurality of electrochemical units 106 that succeed one another in a stack direction 104, such as fuel cell units or electrolysis units, and a clamping device (not illustrated) for applying a clamping force to the electrochemical units in the stack direction 104.

As can best be seen from FIG. 2, each electrochemical unit 106 of the electrochemical device 100 comprises a respective bipolar plate 108 and a membrane electrode assembly (MEA) 110.

The membrane electrode assembly 110 comprises for example a catalyst-coated membrane (CCM) and two gas diffusion layers 112 and 114, wherein a first gas diffusion layer 112 is arranged on the anode side and a second gas diffusion layer 114 on the cathode side.

The bipolar plate 108 is made for example from a metal material.

The bipolar plate 108 has a plurality of medium passage openings 116 through each of which a fluid medium to be supplied to the electrochemical device 100 (in the case of a fuel cell stack, for example an anode gas, a cathode gas or a coolant) can pass through the bipolar plate 108.

The medium passage openings 116 of the bipolar plates 108 succeeding one another in the stack, and the intermediate spaces lying between the medium passage openings 116 in the stack direction 104, together form a respective medium duct 118.

Associated with each medium duct 118 through which a fluid medium of the electrochemical device 100 is suppliable is in each case at least one other medium duct through which the relevant fluid medium is dischargeable from the electrochemical device 100.

The medium can flow transversely, preferably substantially perpendicularly, to the stack direction 104, out of the first medium duct 118 and to the second medium duct through a flow field 120 which lies between them and is preferably formed on a surface of an adjacent bipolar plate 108 or (for example in the case of a coolant flow field) in the intermediate space between the layers of a multiple-layer bipolar plate 108.

In FIG. 1, for example a medium duct 122 for a coolant of the electrochemical device 100 and a medium duct 124 for an anode gas of the electrochemical device 100 are illustrated.

Each medium duct 118 is in fluidic connection with the respectively associated flow field 120 through a respective connection duct 126.

In the embodiment illustrated in the drawings, each bipolar plate 108 comprises a first bipolar plate layer 132 and a second bipolar plate layer 134, which are fixed fluid-tightly to one another, preferably by a substance-to-substance bond, in particular by welding, for example laser welding, along connection conduits 130 that are illustrated in FIG. 1 by broken lines.

As can be seen from FIG. 1, the medium duct 122 for coolant is in fluidic connection, by way of a connection duct 136 for coolant that is formed by an intermediate space between the first bipolar plate layer 132 and the second bipolar plate layer 134 of the bipolar plate 108, with a flow field for the coolant, which is formed in the intermediate space between the first bipolar plate layer 132 and the second bipolar plate layer 134 of the bipolar plate 108.

As can be seen from FIG. 2, the medium duct 124 for anode gas is in fluidic connection, by way of a connection duct 142 for anode gas, with a flow field 144 for the anode gas, which is formed between the first bipolar plate layer 132 of the bipolar plate 108 and the first gas diffusion layer 112.

The connection duct 142 comprises a connection chamber 146, which is formed by an intermediate space between the first bipolar plate layer 132 and the second bipolar plate layer 134 of the bipolar plate 108, and which is in fluidic connection with the medium duct 124 by way of ingress openings 148 facing the medium duct 124 for anode gas, and is in fluidic connection with the flow field 144 by way of gas passage openings 150 facing the flow field 144 for the anode gas.

In order to guide the flow of media through the respectively associated flow fields, the first bipolar plate layer 132 and the second bipolar plate layer 134 of the bipolar plate 108 are provided, in the region of the flow fields 120, with flow-guide elements 152 which may for example take the form of raised beads.

The first bipolar plate layer 132 and the second bipolar plate layer 134 abut against one another in a common main plane 154.

The main plane 154 is oriented perpendicular to the stack direction 104 and runs through the contact faces 156 at which the two bipolar plate layers 132 and 134 of the bipolar plate 108 abut against one another.

Thus, the main plane 154 preferably forms a central plane of the multiple-part bipolar plate 108.

Undesirable egress of the fluid media out of the medium ducts 118 and the flow fields 120 of the electrochemical device 100 is prevented by a seal arrangement 158, of which sealing lines 160 are illustrated in the plan view of FIG. 1 by dot-and-dash lines.

The seal arrangement 158 comprises a flow field portion 162 having the outer sealing line 160a and the inner sealing line 160b, which run between the flow fields 120 on the one hand and the medium ducts 118 on the other and traverse the connection ducts 126 through which the flow fields 120 and the respectively associated medium ducts 118 are in fluidic connection with one another.

Further, the seal arrangement 158 comprises medium duct portions 164 having sealing lines 160c, which respectively surround one of the medium ducts 118, at least in certain regions, and separate the relevant medium duct 118 from an outer edge 166 of the bipolar plate 108.

The medium duct portions 164 of the seal arrangement 158 each comprise a sealing element 168, which is arranged between a first bipolar plate layer 132 of a bipolar plate 108 and a second bipolar plate layer 134 of a bipolar plate 108′ that is adjacent in the stack direction 104, and which extends substantially parallel to an edge 170 of a medium passage opening 116 of the relevant medium duct 118.

The flow field portion 162 of the seal arrangement 158 preferably comprises two sealing elements 172a and 172b, which are likewise arranged between the first bipolar plate layer 132 of the bipolar plate 108 and the second bipolar plate layer 134 of the adjacent bipolar plate 108′.

In this case, the first sealing element 172a is preferably fixed to the (for example anode-side) first gas diffusion layer 112, and the second sealing element 172b is preferably fixed to the (for example cathode-side) second gas diffusion layer 114 of the membrane electrode assembly 110.

For example, it may be provided for the sealing elements 172a and 172b to be moulded or cast onto the respectively associated gas diffusion layer 112 or 114.

In this case, it may be provided for the first sealing element 172a to abut for example in the region of the outer sealing line 160a against both the first layer 132 of the bipolar plate 108 and also the second layer 134 of the adjacent bipolar plate 108′ and in the region of the inner sealing line 160b against the first layer 132 of the bipolar plate 108 and the second sealing element 172b, while the second sealing element 172b abuts in the region of the inner sealing line 160b against the second layer of the bipolar plate 108′ and the first sealing element 172a.

The sealing elements 168 of the medium duct portions 164 of the seal arrangement 158 may take a form in one piece with the first sealing element 172a of the flow field portion 162 of the seal arrangement 158.

The seal arrangement 158 may thus be formed in two parts, wherein a first part 192 of the seal arrangement 158 comprises the first sealing element 172a of the flow field portion 162 and the sealing elements 168 of the medium duct portions 164, and is preferably carried by the first gas diffusion layer 112, and wherein a second part 194 of the seal arrangement 158 comprises the second sealing element 172b of the flow field portion 162, and is preferably carried by the second gas diffusion layer 114.

As can be seen from FIG. 2, the first bipolar plate layer 132 and the second bipolar plate layer 134 respectively comprise, in the region of the connection duct 126, support points 174 that abut against each other by means of contact faces 176, in order to support one another and to keep the upper delimitation wall and the lower delimitation wall of the connection duct 126 at a spacing from one another.

The gas flowing through the connection duct 126 flows laterally past the support points 174 to the gas passage openings 150.

The gas passage openings 150 are formed in an edge web 178 of the first bipolar plate layer 132 which borders the flow field 120 of the first bipolar plate layer 132.

The edge web 178 comprises a flank 180 that faces the flow field 120 and is on the flow field side, a flank 182 that faces the medium duct 118 and is on the medium duct side, and a crest region 184 that connects the flank 182 on the medium duct side and the flank 180 on the flow field side to one another.

In the exemplary embodiment illustrated in FIG. 2, the crest region 184 is substantially planar and is oriented substantially parallel to the main plane 154 of the bipolar plate 108 and the first bipolar plate layer 132.

The crest region 184 abuts against the first gas diffusion layer 112 of the membrane electrode assembly 110 of the respective electrochemical unit 106.

The flank 180 of the edge web 178 that is on the flow field side and in which the gas diffusion openings 150 are arranged is inclined at a flank angle α of more than 60°, for example approximately 63°, to the main plane 154 of the bipolar plate 108.

In the region of the connection duct 126, the edge web 178 has the same height H₀ everywhere and also the same cross section everywhere—apart from the gas passage openings 150, which succeed one another in a longitudinal direction 186 of the edge web 178 and are at a spacing from one another in the longitudinal direction 186.

The longitudinal direction 186 of the edge web 178 runs parallel to a local peripheral direction 188 of the flow field 120.

The bipolar plate layer 132 illustrated in FIG. 2 is made from a planar starting material by a stamping and punching procedure.

After stamping and punching, the gas passage openings 150 are separated out of the flank 180 of the already shaped edge web 178 that is on the flow field side, by laser cutting.

During operation of the electrochemical device 100, the gas flows through the gas passage openings 150 that are made by laser cutting, out of the connection duct 126 and into the adjacent flow field 120.

If the gas passage openings 150 were produced in an edge web portion of the starting material out of which the edge web 178 is later shaped, then as a result of the change in shape and the shaping work during the shaping procedure by which the three-dimensional edge web 178 is shaped out of the edge web portion of the starting material the gas passage openings 150 would be widened to too great an extent, and would extend into both the crest region 184 of the edge web 178 and also into the duct root 190 of the outermost duct 196 of the flow field 120, adjacent to the edge web 178, which is undesirable.

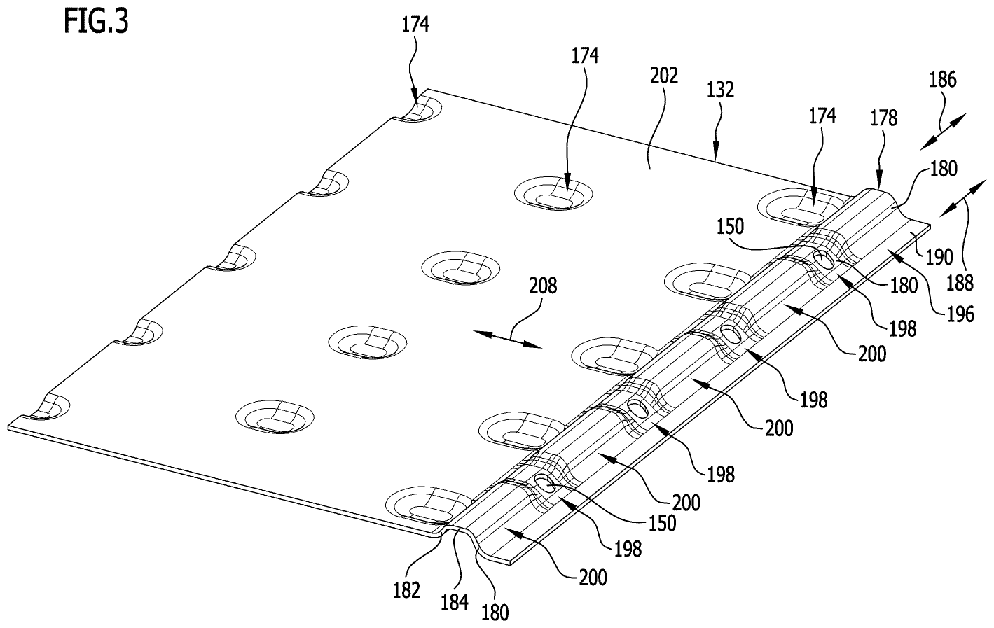

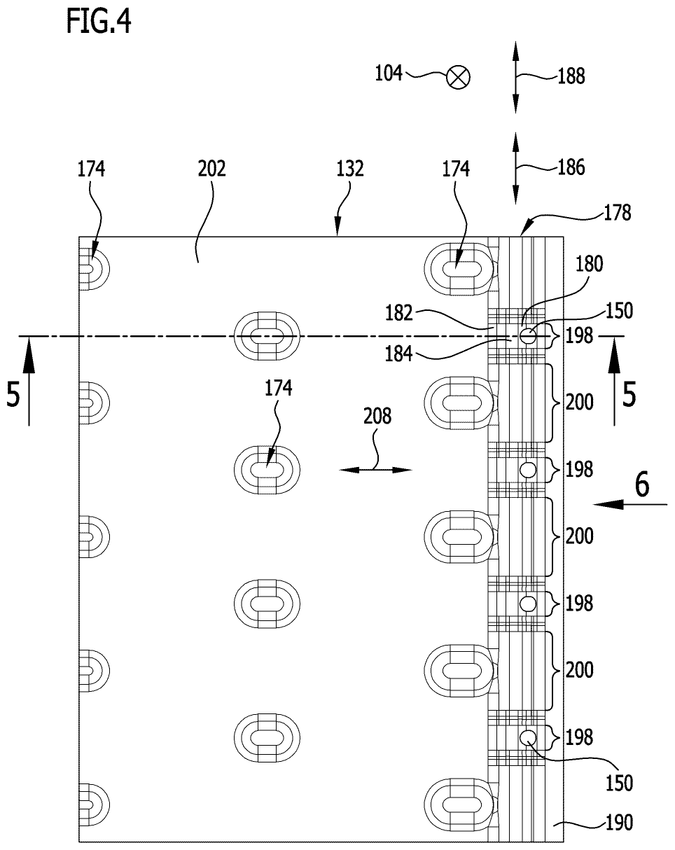

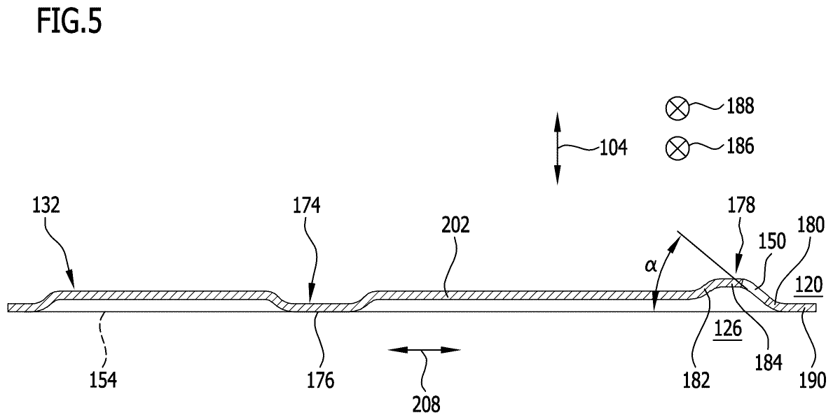

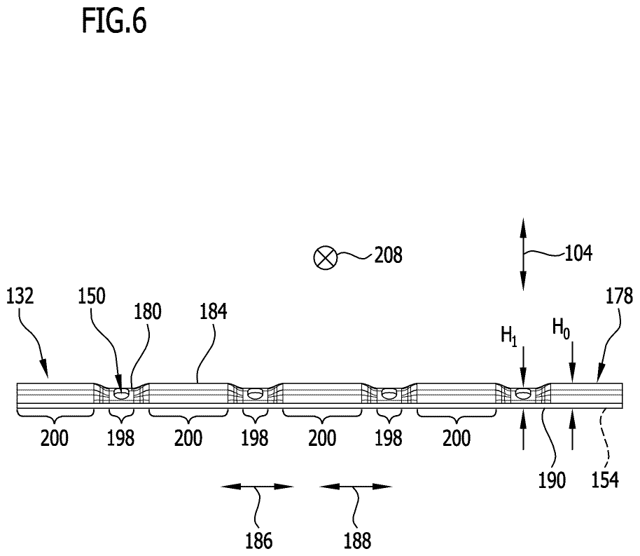

In the first alternative embodiment of the bipolar plate layer 132, illustrated in FIGS. 3 to 6, it is therefore provided for the edge web 178 to have a smaller height H₁, and thus a smaller spacing from the main plane 154 of the bipolar plate layer 132, in opening portions 198 that are provided with a respective one of the gas passage openings 150 than in intermediate portions 200 of the edge web 178 lying between two respective opening portions 198 of the edge web 178.

The effect of this reduction in height from the value H₀ to the value H₁ in the opening portions 198 of the edge web 178 is that the flank 180 of the edge web 178 on the flow field side forms a flank angle α with the main plane 154 of the bipolar plate layer 132 that is less than 60°, preferably less than 50°, and in the exemplary embodiment illustrated in the drawing approximately 40°.

Moreover, when the electrochemical device 100 is in an operational condition, the crest region 184 of the edge web 178 in the opening portions 198 is at a spacing from the gas diffusion layer 112 against which the crest region 184 in the intermediate regions 200 of the edge web 178 abuts.

This makes it possible for the gas passage openings 150 to extend from the flank 180 on the flow field side into the crest region 184 of the edge web 178.

In this embodiment, the edge regions of the edge web 178 which border the respective gas passage openings 150 thus take—as seen from the outer side of the edge web 178, remote from the connection duct 126—a convexly curved form, at least in certain regions (namely in their portion lying within the crest region 184 of the edge web 178).

As a result of the local reduction in height of the edge web 178 in the opening portions 198 of the edge web 178, and the associated reduction in the flank angle α of the flank 180 of the edge web 178 on the flow field side at the locations at which the gas passage openings 150 are arranged, the gas passage openings 150 are no longer widened to too great an extent during the procedure of shaping the edge web portion of the planar starting material into the three-dimensional edge web 178.

Thus, it is possible, because of this change in the construction of the edge web 178, to make the gas passage openings 150 in the starting material and, once the gas passage openings 150 have been separated out of the edge web portion of the starting material, to shape this edge web portion such that the edge web 178 is formed from the edge web portion of the starting material.

In this case, the gas passage openings 150 may for example be separated out of the edge web portion of the starting material by being punched out.

Because the gas passage openings 150 are produced by a punching out procedure before the starting material is shaped into the bipolar plate layer 132, it is possible to manufacture the bipolar plate layer 132 in a progressive tool by a progressive process.

In this case, in a first stage of the progressive tool, the gas passage openings 150 are separated out of the edge web portion of the starting material by being punched out, and in a second stage of the progressive tool the flow field 120 and the edge web 178 are produced by being shaped, for example by a stamping procedure.

As a result, the complicated process step of laser cutting in the production of the bipolar plate layer 132 is dispensed with, and the throughput time of the bipolar plate layer 132 through the production process is reduced.

Here, the construction of the bipolar plate layer 132 is still compact and can be manufactured by low-cost industrial mass production.

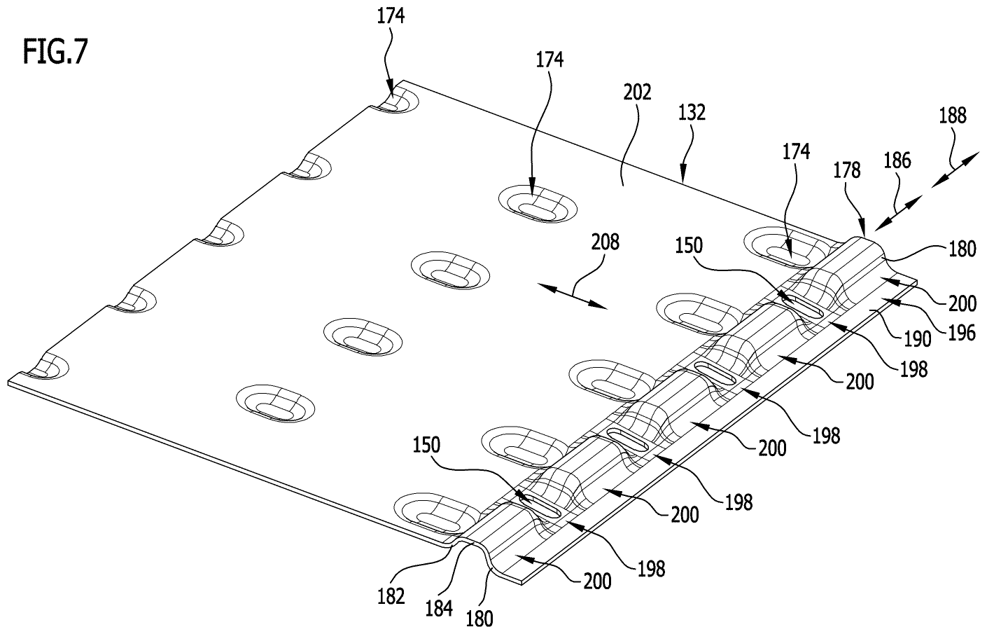

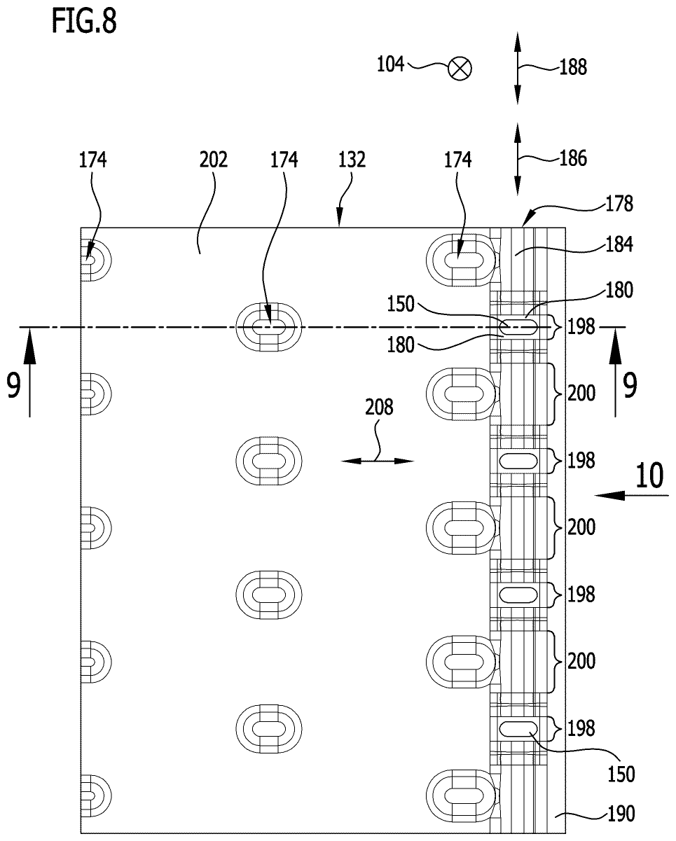

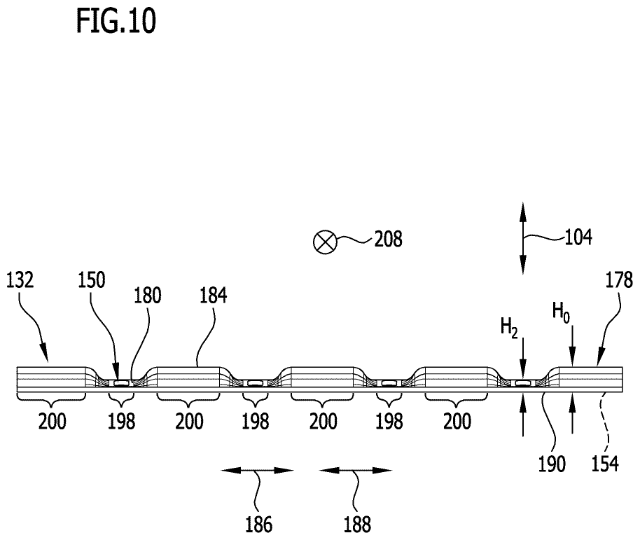

A second embodiment of a bipolar plate layer 132, illustrated in FIGS. 7 to 10, differs from the first embodiment illustrated in FIGS. 3 to 6 in that the edge web 178 does not have a flank 182 on the medium duct side.

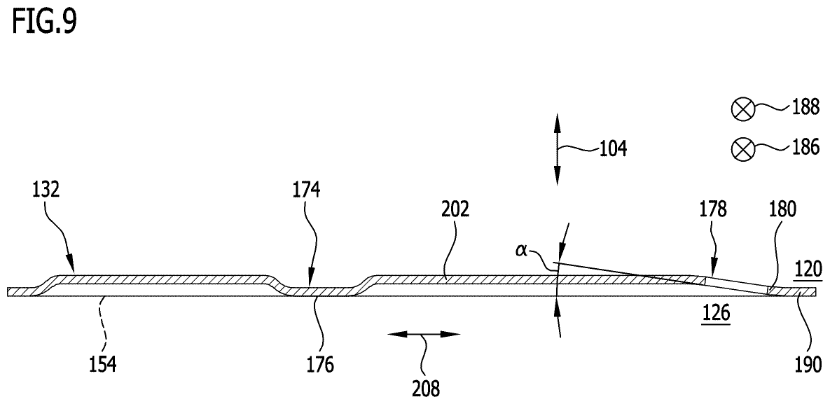

Rather, in this embodiment, as can best be seen from FIG. 9, the flank 180 of the edge web 178 on the flow field side merges in the opening portions 198 directly into a planar region 202 of the bipolar plate layer 132, which forms a delimitation wall of the connection duct 126 and from which the support points 174 extend into the interior of the connection duct 126 as far as the second bipolar plate layer 134.

In this embodiment, the gas passage openings 150 of the edge web 178 are formed entirely in the flank 180 of the edge web 178 on the flow field side, in the region of the opening portions 198, where the flank 182 on the flow field side is substantially planar.

As can best be seen from FIG. 9, in this embodiment the flank angle α of the flank 180 on the flow field side in the opening portions 198 of the edge web 178 is particularly small, preferably less than 10°, for example 9°.

Because of this small flank angle α, in this second embodiment the height H₂ of the edge web 178 in the opening portions 198 is particularly small by comparison with the height H₀ of the edge web 178 in the intermediate portions 200.

Consequently, the degree of shaping the starting material to which the edge web portion of the starting material has to be subjected in the opening portions 198 in order to form the edge web 178 of the second embodiment from the edge web portion of the planar starting material by a shaping procedure, in particular a stamping procedure, is particularly small.

The gas passage openings 150 that are made out of the edge web portion of the planar starting material by being punched out thus undergo only a small change in shape during formation of the edge web 178 out of the edge web portion by a shaping procedure, with the result that tears in the edges of the gas passage openings 150 can largely be prevented, and the final form taken by the gas passage openings 150 in the edge web 178 that has been given its final form is particularly readily controllable.

Otherwise, the second embodiment of a bipolar plate layer 132 that is illustrated in FIGS. 7 to 10 corresponds, as regards its structure, functioning and method of manufacture, to the first embodiment illustrated in FIGS. 3 to 6, and in this respect reference is made to the description thereof above.

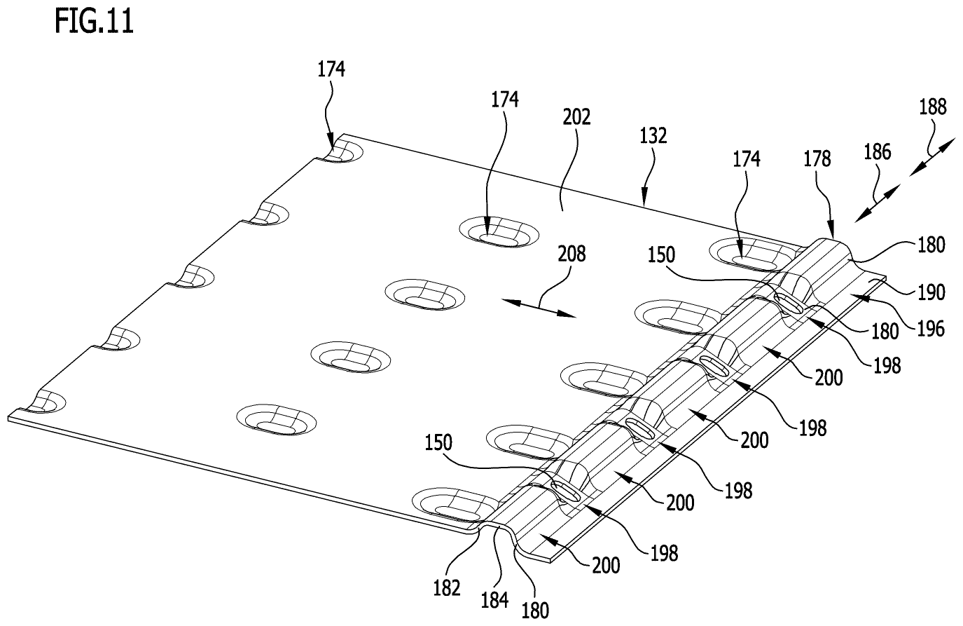

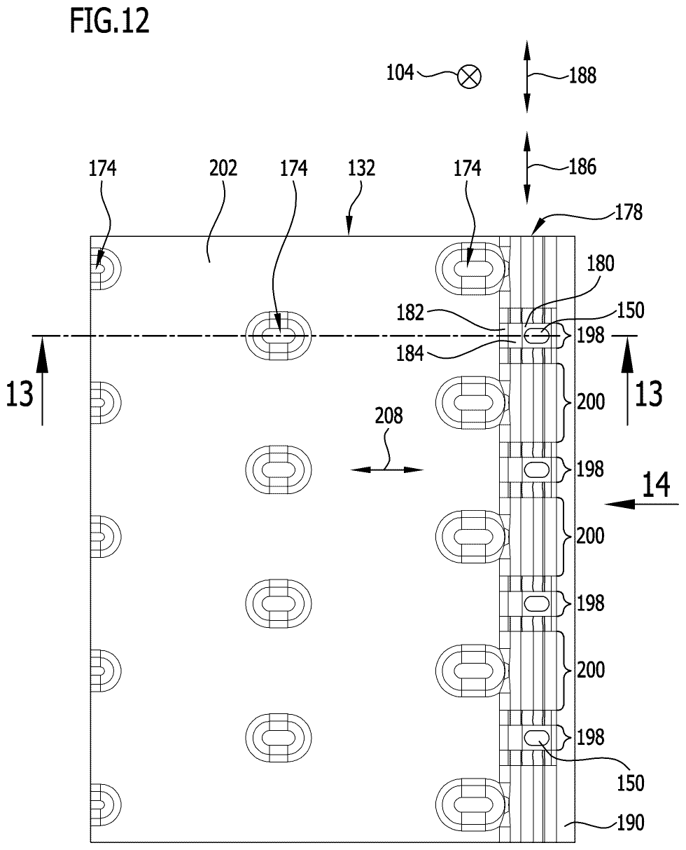

A third embodiment of a bipolar plate layer 132, illustrated in FIGS. 11 to 13, differs from the first embodiment illustrated in FIGS. 3 to 6 in that the flank angle α of the flank 180 of the edge web 178 on the flow field side in the opening portions 198 of the edge web 178 is smaller than in the first embodiment.

For example, it may be provided for the flank angle α of the flank 180 of the edge web 178 on the flow field side in the opening portions 198 to be less than 30°.

Further, it may be provided for the flank angle α of the flank 180 of the edge web 178 on the flow field side in the opening portions 198 to be greater than 20°.

For example, the flank angle α of the flank 180 of the edge web 178 on the flow field side in the opening portions 198 of the edge web 178 may be approximately 24°.

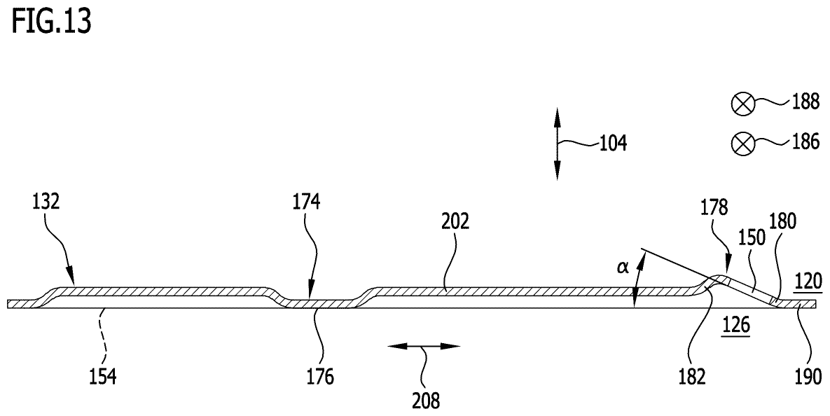

In this embodiment, as can best be seen from the cross section of FIG. 13, the gas passage openings 150 are formed entirely in the flank 180 on the flow field side of the opening portions 198 of the edge web 178.

Further, the flank 180 on the flow field side in the opening portions 198 of the edge web 178 preferably takes a substantially planar form.

In this embodiment, therefore, the edge regions of the edge web 178 which border the gas passage openings 150 take a substantially planar form.

Further, in this embodiment the crest region 184 of the edge web 178 in the opening portions 198 does not take a planar form, substantially parallel to the main plane 154 of the bipolar plate layer 132, but—as seen from the outer side of the edge web 178, remote from the connection duct 126 when the electrochemical device 100 is in an operational condition—takes a convexly curved form.

In this third embodiment, the height H₃ of the edge web 178 in the opening portions 198 is preferably greater than the height H₂ of the edge web 178 in the opening portions 198 in the second embodiment, illustrated in FIGS. 7 to 10, and is preferably smaller than the height H₁ of the edge web 178 in the opening portions 198 in the first embodiment, illustrated in FIGS. 3 to 6, in each case relative to the height H₀ of the edge web 178 in the intermediate portions 200 of the respective edge web 178.

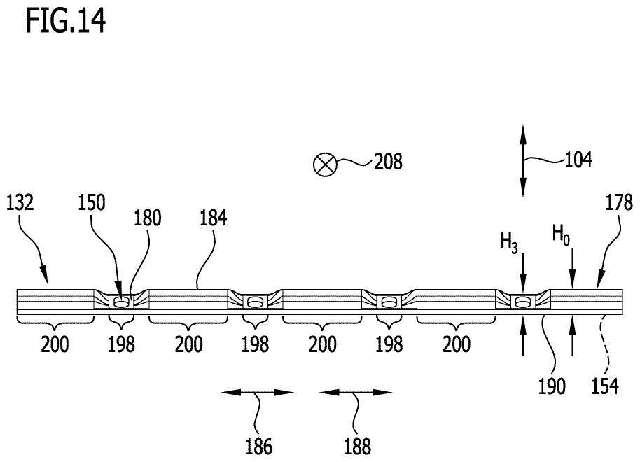

Otherwise, the third embodiment of a bipolar plate layer 132 that is illustrated in FIGS. 11 to 14 corresponds, as regards its structure, functioning and method of manufacture, to the first embodiment illustrated in FIGS. 3 to 6, and in this respect reference is made to the description thereof above.

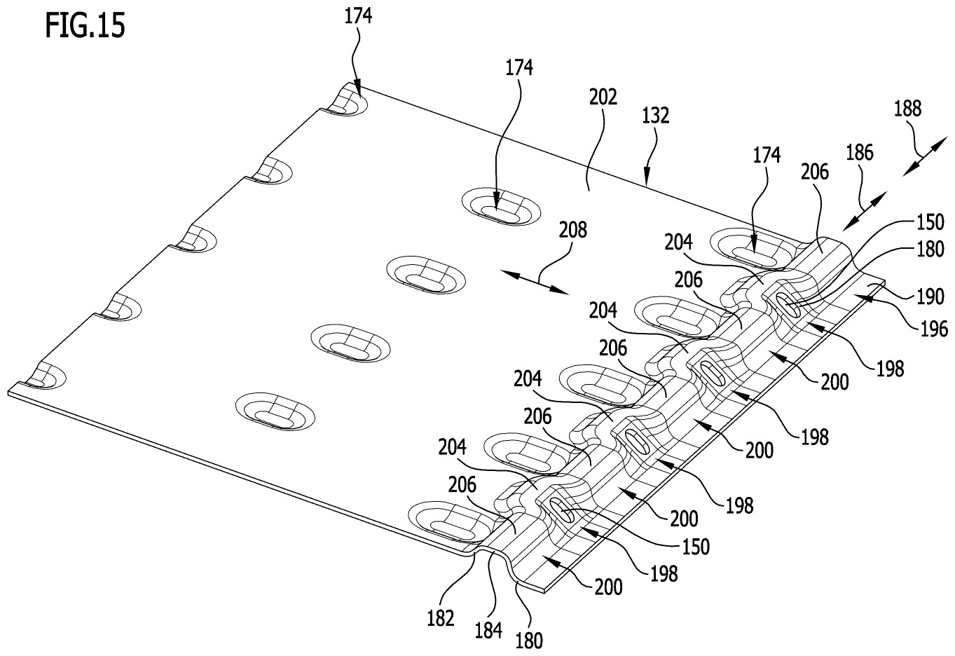

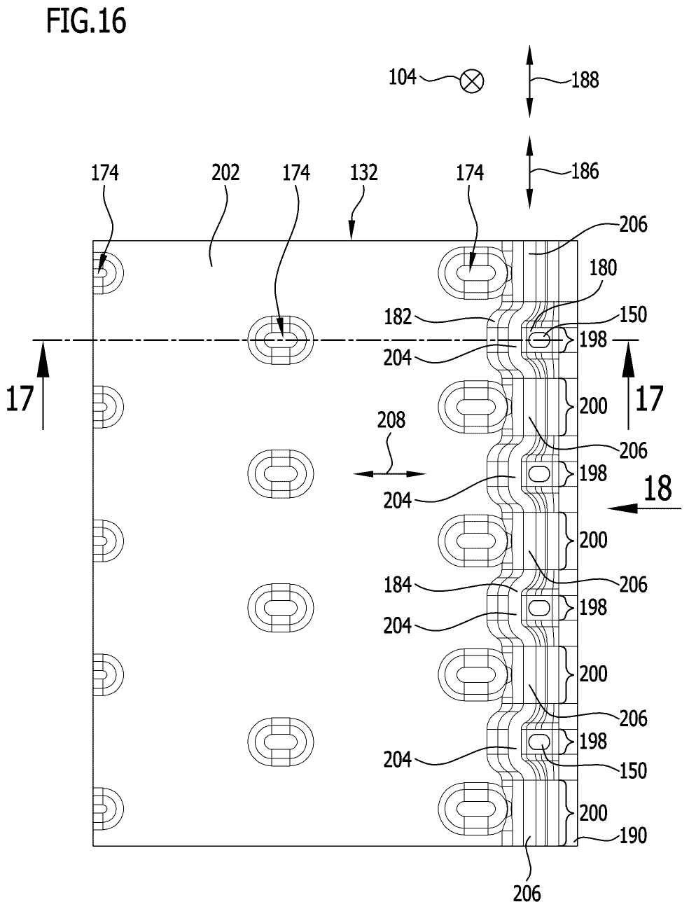

A fourth embodiment of a bipolar plate layer 132, illustrated in FIGS. 15 to 18, differs from the first embodiment illustrated in FIGS. 3 to 6 in that the crest region 184 of the edge web 178 at which the edge web 178 has its greatest height H₀ takes the shape of a wave as seen in a plan view of the edge web 178 in the stack direction 104.

In particular, the crest region portions 204 in the opening portions 198 of the edge web 178 are offset from the crest region portions 206 in the intermediate portions 200 of the edge web 178 in a transverse direction 208, oriented perpendicular to the stack direction 104 and perpendicular to the longitudinal direction 186 of the edge web 178, away from the flow field 120 in the direction toward the medium duct 118.

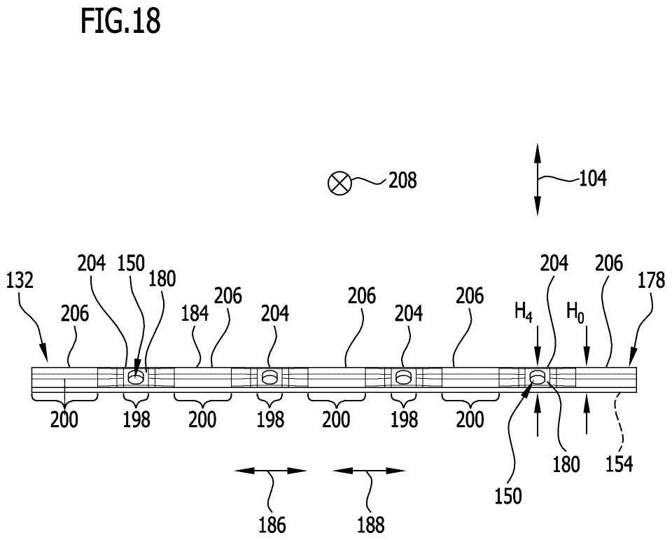

In this third embodiment, as can best be seen from FIG. 18, the height H₄ of the edge web 178 in the opening portions 198 of the edge web 178 is the same size as the height H₀ of the edge web 178 in the intermediate portions 200.

Nonetheless, the flank angle α of the flank 180 of the edge web 178 on the flow field side in the opening portions 198 is reduced by comparison with the embodiment of a bipolar plate layer 132 that is illustrated in FIG. 2, because the offset of the crest region portions 204 in the opening portions 198 away from the flow field 120 has the effect that the length of the flank 180 on the flow field side is greater in the transverse direction 208, by way of which this height H₄=H₀ of the edge web 178 in the opening portions 198 is achieved, as a result of which the flank angle α is reduced without the width of the edge web 178 in the intermediate portions 200 likewise having to be increased.

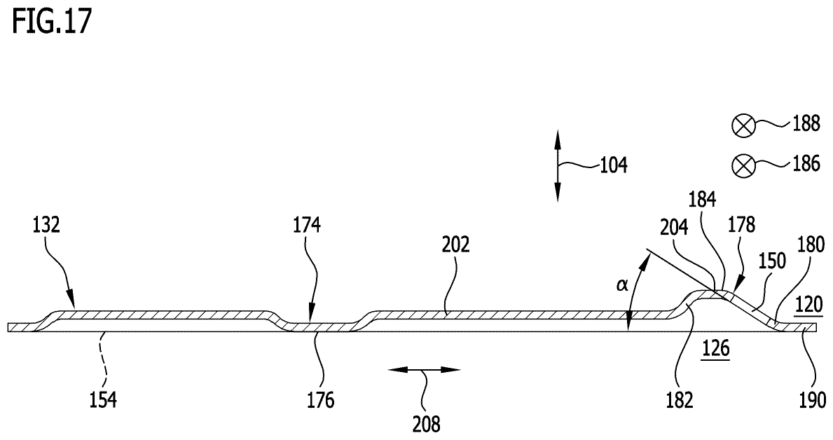

As can best be seen from FIG. 17, in the fourth embodiment of a bipolar plate layer 132 the gas passage openings 150 are formed entirely in the flanks 180 of the opening portions 198 on the flow field side.

Further, in this embodiment the flanks 180 of the opening portions 198 on the flow field side take a substantially planar form.

In this fourth embodiment of a bipolar plate layer 132, therefore, the edge regions of the edge web 178 which border the gas passage openings 150 take a substantially planar form.

Otherwise, the fourth embodiment of a bipolar plate layer 132 for a bipolar plate 108 of an electrochemical unit 106 of an electrochemical device 100 that is illustrated in FIGS. 15 to 18 corresponds, as regards its structure, functioning and method of manufacture, to the first embodiment illustrated in FIGS. 3 to 6, and in this respect reference is made to the description thereof above.

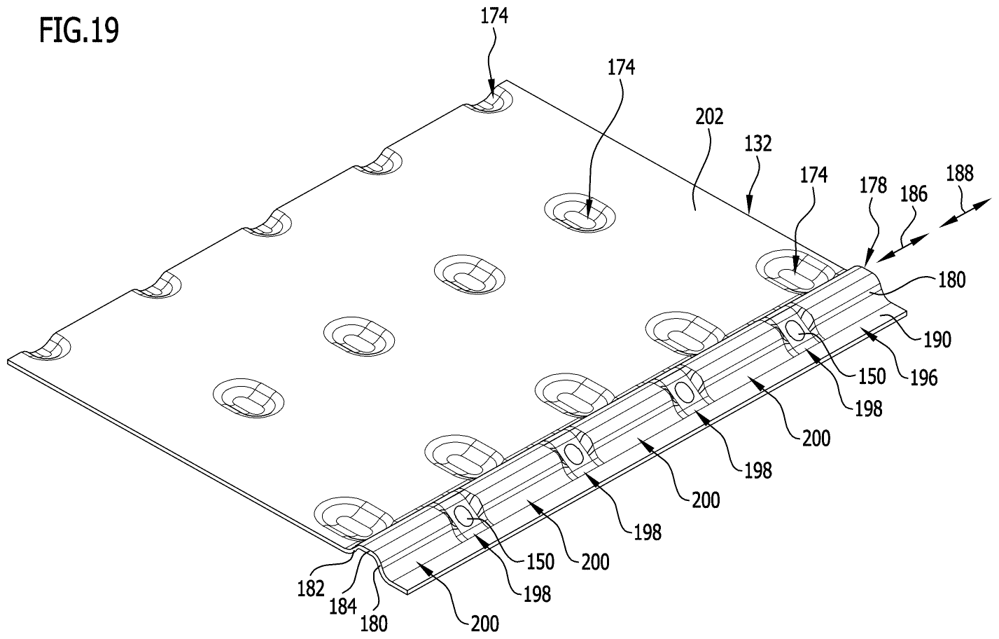

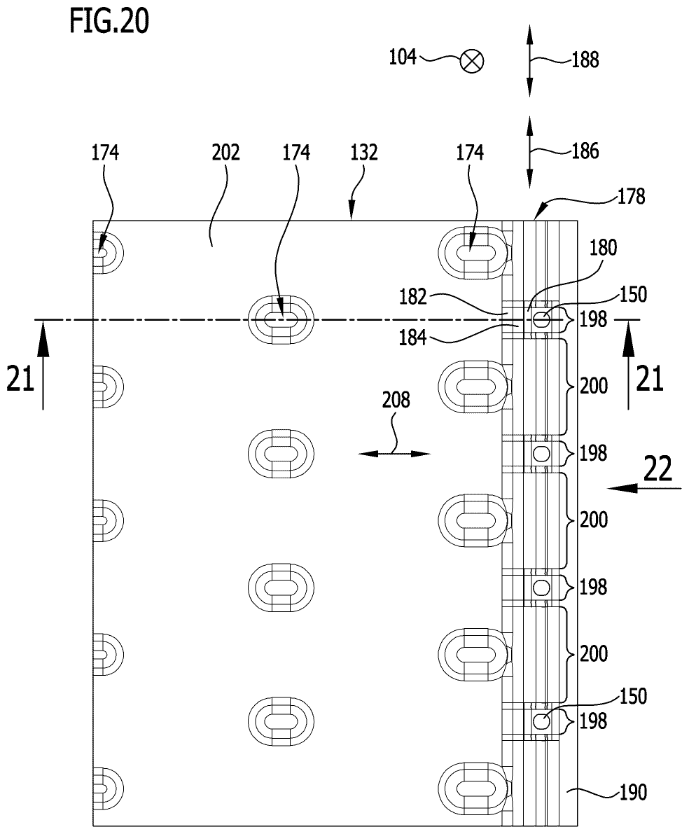

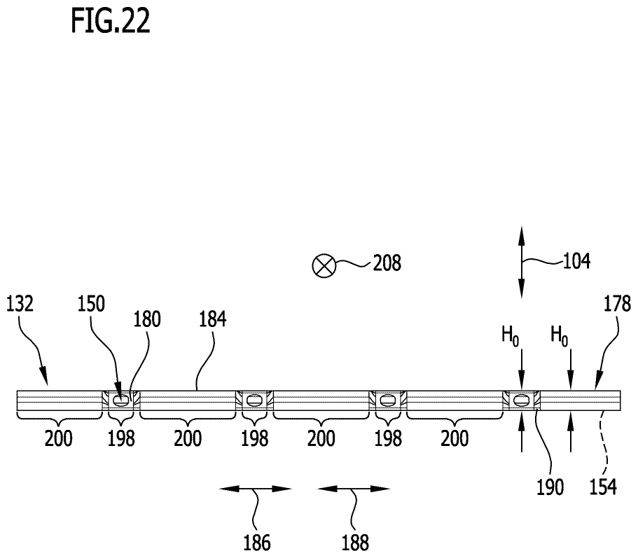

A fifth embodiment of a bipolar plate layer 132, illustrated in FIGS. 19 to 22, differs from the third embodiment illustrated in FIGS. 11 to 14 in that the flank angle α of the flank 180 of the edge web 178 on the flow field side in the opening portions 198 of the edge web 178 is greater than in the third embodiment.

For example, it may be provided for the flank angle α of the flank 180 of the edge web 178 on the flow field side in the opening portions 198 to be greater than 30°, preferably greater than 35°.

Further, it may be provided for the flank angle α of the flank 180 of the edge web 178 on the flow field side in the opening portions 198 to be less than 45°, particularly preferably less than 40°.

For example, the flank angle α of the flank 180 of the edge web 178 on the flow field side in the opening portions 198 of the edge web 178 may be approximately 37°.

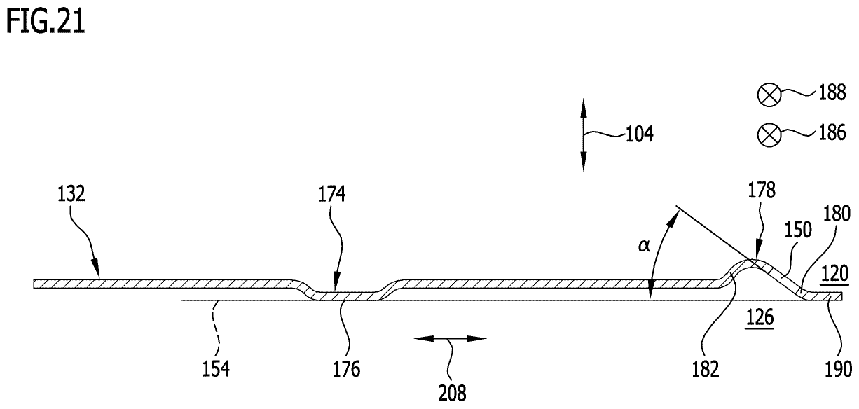

In this embodiment, as can best be seen from the cross section of FIG. 21, the gas passage openings 150 are formed entirely in the flank 180 on the flow field side of the opening portions 198 of the edge web 178.

Further, the flank 180 on the flow field side in the opening portions 198 of the edge web 178 preferably takes a substantially planar form.

In this embodiment, therefore, the edge regions of the edge web 178 which border the gas passage openings 150 take a substantially planar form.

Further, in this embodiment the crest region 184 of the edge web 178 in the opening portions 198 does not take a planar form, substantially parallel to the main plane 154 of the bipolar plate layer 132, but—as seen from the outer side of the edge web 178, remote from the connection duct 126 when the electrochemical device 100 is in an operational condition—takes a convexly curved form.

In this fifth embodiment, the height H₀ of the edge web 178 in the opening portions 198 is preferably the same size as the height H₀ of the edge web 178 in the intermediate portions 200 of the edge web 178.

In the intermediate portions 200 of the edge web 178, the crest region 184 of the edge web 178 takes a substantially planar form, substantially parallel to the main plane 154 of the bipolar plate layer 132.

Otherwise, the fifth embodiment of a bipolar plate layer 132 that is illustrated in FIGS. 19 to 22 corresponds, as regards its structure, functioning and method of manufacture, to the third embodiment illustrated in FIGS. 11 to 14, and in this respect reference is made to the description thereof above.

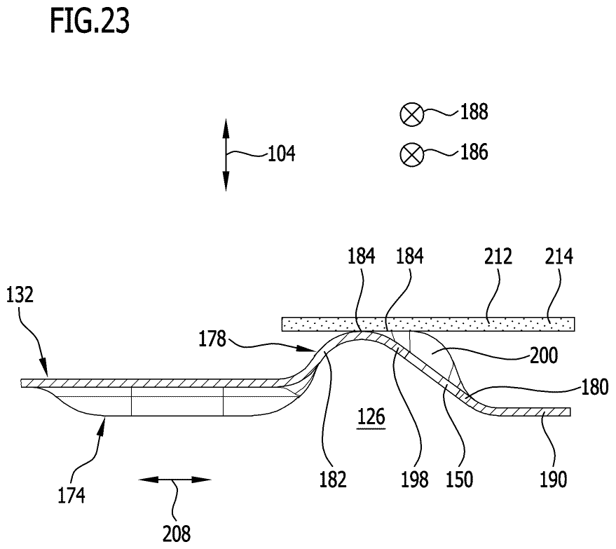

FIG. 23 illustrates how, in the assembled condition of the electrochemical unit 106 of the electrochemical device 100, the edge web 178 of the bipolar plate layer 132 according to the fifth embodiment that is described above is in contact with a porous element 212.

In this case, in the intermediate portions 200 of the edge web 178 the porous element 212 abuts flat against the crest region 184 of the edge web 178, which takes a planar form there, while in the opening portions 198 of the edge web 178 the porous element 212 abuts linearly against the crest region 184 of the edge web 178, which is convexly curved there.

The porous element 212 may take the form for example of a gas diffusion layer 214.

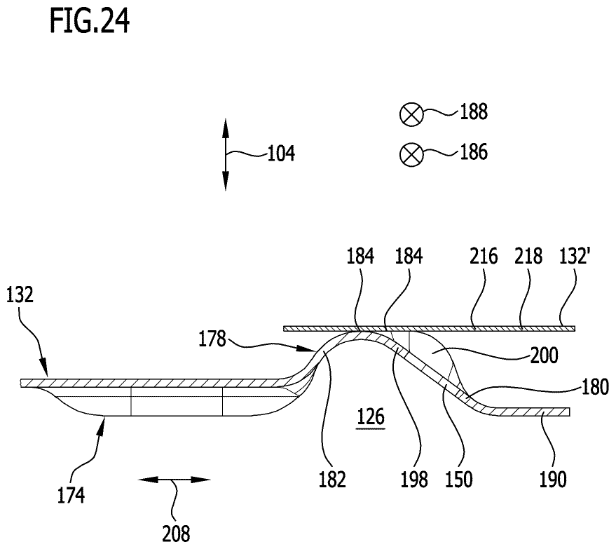

FIG. 24 illustrates how, instead of the porous element 212, a thin film 218 is in contact against the edge web 178 of the bipolar plate layer 132 according to the fifth embodiment that is described above.

In this case, in the intermediate portions 200 of the edge web 178 the thin film 218 abuts flat against the crest region 184 of the edge web 178, which takes a planar form there, while in the opening portions 198 of the edge web 178 the thin film 218 abuts linearly against the crest region 184 of the edge web 178, which is convexly curved there.

The thin film 218 may for example take the form of a membrane 216, such as a catalyst-coated membrane (CCM), or a further bipolar plate layer 132′.

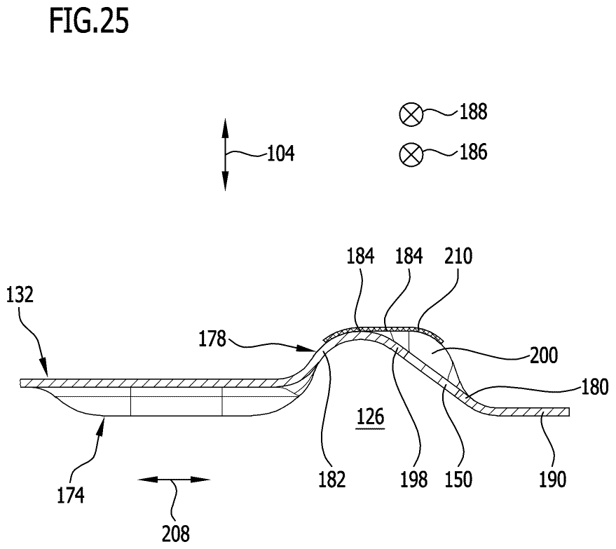

FIG. 25 shows a first variant of the fifth embodiment of a bipolar plate layer 132 that is illustrated in FIGS. 19 to 22, in which, in the crest region 184 of the edge web 178, the bipolar plate layer 132 is provided with a coating 210, which is preferably made from an elastomer material.

In this case, the coating 210 preferably extends—at least in the intermediate portions 200 of the edge web 178—over the entire width of the crest region 184, that is to say over its entire extent in the transverse direction 208.

The convexly curved crest region 184 in the opening portions 198 of the edge web 178 may likewise be provided with a coating 210, preferably of an elastomer material. As an alternative to this, it may be provided for the crest region 184 to remain uncoated in the opening portions 198.

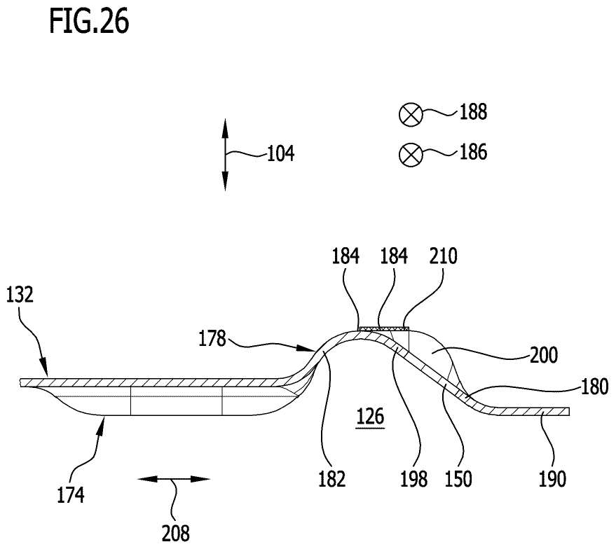

A second variant, illustrated in FIG. 26, of the fifth embodiment of a bipolar plate layer 132, which is illustrated in FIGS. 19 to 22, differs from the first variant illustrated in FIG. 25 in that the coating 210 provided on the crest region 184 of the edge web 178 in the intermediate portions 200 does not extend over the entire width, that is to say the extent in the transverse direction 208, of the crest region 184, but only over a narrower part of the crest region 184, preferably a central portion of the crest region 184 arranged in the middle of the edge web 178.

In this variant too, in the opening portions 198 the crest region 184 of the edge web 178 may likewise be provided with a coating 210, preferably of an elastomer material, or remain uncoated.

Otherwise, the first and second variants, illustrated in FIGS. 25 and 26, of the fifth embodiment of a bipolar plate layer 132 that is illustrated in FIGS. 19 to 22 correspond, as regards their structure, functioning and method of manufacture, to the fifth embodiment illustrated in FIGS. 19 to 22, and in this respect reference is made to the description thereof above.

1. A method for manufacturing a bipolar plate layer for a bipolar plate of an electrochemical unit of an electrochemical device, comprising the following:
providing a starting material for the bipolar plate layer;
shaping the starting material such that an edge web which borders a flow field of the bipolar plate layer is formed; and
separating out gas passage openings from an edge web portion of the starting material, wherein after the gas passage openings have been separated out the edge web portion is shaped such that the edge web is formed from the edge web portion.

2. A method according to claim 1, wherein the gas passage openings are separated out of the edge web portion of the starting material by being punched out.

3. A method according to claim 1, wherein the edge web portion of the starting material is given a shape, after the gas passage openings have been separated out, such that the edge regions of the edge web which border the gas passage openings are inclined in relation to a main plane of the bipolar plate layer, which in the assembled condition of the bipolar plate is oriented perpendicular to a stack direction of the electrochemical device, by an angle (α) of less than 70°.

4. A method according to claim 1, wherein the edge web portion of the starting material is given a shape, after the gas passage openings have been separated out, such that the edge regions of the edge web which border the gas passage openings take a substantially planar form.

5. A method according to claim 1, wherein the edge web portion of the starting material is given a shape, after the gas passage openings have been separated out, such that the edge regions of the edge web which border the gas passage openings take—as seen from the outer side of the edge web—a convexly curved form, at least in certain regions.

6. A method according to claim 1, wherein the edge web portion of the starting material is given a shape, after the gas passage openings have been separated out, such that the edge web has the same height (H₀) in opening portions that are each provided with a gas passage opening as in intermediate portions of the edge web lying between two respective opening portions.

7. A method according to claim 1, wherein the edge web portion of the starting material is given a shape, after the gas passage openings have been separated out, such that the edge web has a smaller height (H₁; H₂; H₃) in opening portions that are each provided with a gas passage opening than in intermediate portions of the edge web lying between two respective opening portions.

8. A method according to claim 7, wherein the edge web portion of the starting material is given a shape, after the gas passage openings have been separated out, such that the height (H₁; H₂; H₃) of the edge web in the opening portions is less than 80% of the height (H₀) of the edge web in the intermediate portions.

9. A method according to claim 1, wherein the edge web portion of the starting material is given a shape, after the gas passage openings have been separated out, such that a crest region of the edge web, at which the edge web has its greatest height (H₀), takes the shape of a wave as seen in a plan view of the edge web.

10. A method according to claim 9, wherein the crest region of the edge web takes a substantially planar form.

11. A method according to claim 9, wherein the gas passage openings do not extend into the crest region of the edge web.

12. A method according to claim 1, wherein a crest region of the edge web is provided with a coating of an elastomer material.

13. A bipolar plate layer for a bipolar plate of an electrochemical unit of an electrochemical device, comprising an edge web which borders a flow field of the bipolar plate layer, wherein a plurality of gas passage openings are arranged in the edge web,
wherein
the gas passage openings are separated out of a starting material of the bipolar plate layer by being punched out.

14. A bipolar plate layer according to claim 13, wherein the edge regions of the edge web which border the gas passage openings are inclined in relation to a main plane of the bipolar plate layer, which in the assembled condition of the bipolar plate layer is oriented perpendicular to a stack direction of the electrochemical device, by an angle (α) of less than 70°.

15. A bipolar plate layer according to claim 13, wherein the edge web has the same height (H₀) in opening portions that are each provided with a gas passage opening as in intermediate portions of the edge web lying between two respective opening portions.

16. A bipolar plate layer according to claim 13, wherein the edge web has a smaller height (H₁;
H₂; H₃) in opening portions that are each provided with a gas passage opening than in intermediate portions of the edge web lying between two respective opening portions.

17. A bipolar plate layer according to claim 13, wherein a crest region of the edge web, at which the edge web has its greatest height (H₀), takes the shape of a wave as seen in a plan view of the edge web.

18. A bipolar plate layer according to claim 13, wherein a crest region of the edge web is provided entirely or in part with a coating of an elastomer material.

19. An electrochemical unit for an electrochemical device, comprising
a bipolar plate layer for a bipolar plate of an electrochemical unit of the electrochemical device, comprising an edge web which borders a flow field of the bipolar plate layer, wherein a plurality of gas passage openings are arranged in the edge web, wherein the gas passage openings are separated out of a starting material of the bipolar plate layer by being punched out,
and a membrane electrode assembly that comprises a gas diffusion layer,
wherein
an edge web which borders a flow field of the bipolar plate layer is at a spacing from the gas diffusion layer in opening portions that are each provided with a gas passage opening, and is in contact with the gas diffusion layer in intermediate portions of the edge web lying between two respective opening portions.

20. A electrochemical unit according to claim 19, wherein, in the assembled condition of the electrochemical unit, a crest region of the edge web is in contact with a gas diffusion layer, a membrane, a sealing element or another bipolar plate layer.
